(19) United States
(12) Patent Application Publication
(10) Pub. No.: US 2026/0332586 A1
(43) Pub. Date: Oct. 22, 2026

(54) LOWER LAYER SECURITY POLICY DISTRIBUTION AND ACTIVATION

(71) Applicant: Lenovo (United States) Inc., Morrisville, NC (US)

(72) Inventors: Andreas Kunz, Ladenburg (DE); Prateek Basu Mallick, Dreieich (DE); Joachim Löhr, Wiesbaden (DE); Sheeba Backia Mary Baskaran, Friedrichsdorf (DE)

(73) Assignee: Lenovo (United States) Inc., Morrisville, NC (US)

(21) Appl. No.: 19/445,144

(22) Filed: Jan. 9, 2026

(51) Int. Cl. H04L 9/40; H04L 69/22

(52) U.S. Cl. CPC H04L 63/0876; H04L 63/162; H04L 63/20; H04L 69/22

(57) ABSTRACT

Various aspects of the present disclosure relate to lower layer security policy distribution and activation. An apparatus, such as a network equipment (NE), receives a lower layer security policy from a network function, the lower layer security policy for protecting one or more medium access control (MAC) control elements (MAC-CEs). An apparatus, such as a user equipment (UE), receives a radio resource control (RRC) message from the NE including a lower layer security policy, and the NE applies the lower layer security policy to the one or more MAC-CEs. In addition, the UE receives, from the NE, a layer 1 (L1)/layer 2 (L2) message including a security header and the one or more MAC-CEs, the security header indicating that the one or more MAC-CEs are protected according to the lower layer security policy. The UE verifies the one or more MAC-CEs based on the security header.

### TECHNICAL FIELD

The present disclosure relates to wireless communications, and more specifically to lower layer security policy distribution and activation.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive, from an NE, a radio resource control (RRC) message including a lower layer security policy for protecting one or more medium access control (MAC) control elements (MAC-CEs); receive, from the NE, a layer 1 (L1)/layer 2 (L2) message including a security header and the one or more MAC-CEs, the security header indicating that the one or more MAC-CEs are protected according to the lower layer security policy; and verify the one or more MAC-CEs based on the security header.

A processor (e.g., a standalone processor chipset, or a component of a UE) for wireless communication is described. The processor may be configured to, capable of, or operable to perform one or more operations as described herein. For example, the processor may be configured to, capable of, or operable to receive, from an NE, an RRC message including a lower layer security policy for protecting one or more MAC-CEs; receive, from the NE, an L1/L2 message including a security header and the one or more MAC-CEs, the security header indicating that the one or more MAC-CEs are protected according to the lower layer security policy; and verify the one or more MAC-CEs based on the security header.

A method performed or performable by a UE for wireless communication is described. The method may include receiving, from an NE, an RRC message including a lower layer security policy for protecting one or more MAC-CEs; receiving, from the NE, an L1/L2 message including a security header and the one or more MAC-CEs, the security header indicating that the one or more MAC-CEs are protected according to the lower layer security policy; and verifying the one or more MAC-CEs based on the security header.

In some implementations of the UE, the processor, and the method described herein, for each of the one or more MAC-CEs, the L1/L2 message includes a respective security header and a respective message authentication code for integrity (MAC-I), and where the respective security header indicates a respective lower layer security policy for each of the one or more MAC-CEs. In some implementations of the UE, the processor, and the method described herein, for each of the one or more MAC-CEs, the L1/L2 message includes a respective information element (IE) indicating timing information for replay protection.

In some implementations of the UE, the processor, and the method described herein, the L1/L2 message includes the security header and a MAC-I for a group of MAC-CEs including at least one of the one or more MAC-CEs, and where the lower layer security policy is the same for the group of MAC-CEs. In some implementations of the UE, the processor, and the method described herein, the L1/L2 message includes an IE indicating timing information for replay protection for the group of MAC-CEs.

In some implementations of the UE, the processor, and the method described herein, at least one MAC-CE of the one or more MAC-CEs excluded from the group of MAC-CEs lack security protection according to the lower layer security policy. In some implementations of the UE, the processor, and the method described herein, the L1/L2 message includes the security header and a MAC-I for the one or more MAC-CEs, and where the lower layer security policy is the same for the one or more MAC-CEs.

In some implementations of the UE, the processor, and the method described herein, the L1/L2 message includes an IE indicating timing information for replay protection for the one or more MAC-CEs. In some implementations of the UE, the processor, and the method described herein, the L1/L2 message includes a MAC header and a MAC payload, the MAC header including the security header and the MAC payload including one or more MAC service data units (SDUs), the one or more MAC-CEs, and one or more of a MAC-I for the one or more MAC-CEs or an IE indicating timing information for replay protection for the one or more MAC-CEs. In some implementations of the UE, the processor, and the method described herein, to verify the one or more MAC-CEs, the UE, the processor, and the method may further be configured to, capable of, operable to, performed to, or performable to decrypt the one or more MAC-CEs when encryption is enabled and verify one or more MAC-Is when integrity protection is enabled.

In some implementations of the UE, the processor, and the method described herein, to indicate that the one or more MAC-CEs are protected according to the lower layer security policy, the security header includes one or more of an indication of whether confidentiality protection is enabled, an indication of whether integrity protection is enabled, or an indication of whether replay protection is enabled. In some implementations of the UE, the processor, and the method described herein, the UE, the processor, and the method may further be configured to, capable of, operable to, performed to, or performable to transmit, to the NE, a protected response message in response to receiving the RRC message.

An NE (e.g., a base station) for wireless communication is described. The NE may be configured to, capable of, or operable to perform one or more operations as described herein. For example, the NE may be configured to, capable of, or operable to receive, from a network function, a lower layer security policy for protecting one or more MAC-CEs; transmit, to a UE, an RRC message including the lower layer security policy; apply the lower layer security policy to the one or more MAC-CEs; and transmit, to the UE, an L1/L2 message including a security header and the one or more MAC-CEs, the security header indicating that the one or more MAC-CEs are protected according to the lower layer security policy.

A processor (e.g., a standalone processor chipset, or a component of a NE) for wireless communication is described. The processor may be configured to, capable of, or operable to perform one or more operations as described herein. For example, the processor may be configured to, capable of, or operable to receive, from a network function, a lower layer security policy for protecting one or more MAC-CEs; transmit, to a UE, an RRC message including the lower layer security policy; apply the lower layer security policy to the one or more MAC-CEs; and transmit, to the UE, an L1/L2 message including a security header and the one or more MAC-CEs, the security header indicating that the one or more MAC-CEs are protected according to the lower layer security policy.

A method performed or performable by an NE (e.g., a base station) for wireless communication is described. The method may include receiving, from a network function, a lower layer security policy for protecting one or more MAC-CEs; transmitting, to a UE, an RRC message including the lower layer security policy; applying the lower layer security policy to the one or more MAC-CEs; and transmitting, to the UE, an L1/L2 message including a security header and the one or more MAC-CEs, the security header indicating that the one or more MAC-CEs are protected according to the lower layer security policy.

In some implementations of the NE, the processor, and the method described herein, for each of the one or more MAC-CEs, the L1/L2 message includes a respective security header and a respective MAC-I, and where the respective security header indicates a respective lower layer security policy for each of the one or more MAC-CEs. In some implementations of the NE, the processor, and the method described herein, for each of the one or more MAC-CEs, the L1/L2 message includes a respective IE indicating timing information for replay protection.

In some implementations of the NE, the processor, and the method described herein, the L1/L2 message includes the security header and a MAC-I for a group of MAC-CEs including at least one of the one or more MAC-CEs, and where the lower layer security policy is the same for the group of MAC-CEs. In some implementations of the NE, the processor, and the method described herein, the L1/L2 message includes the security header and a MAC-I for the one or more MAC-CEs, and where the lower layer security policy is the same for the one or more MAC-CEs.

In some implementations of the NE, the processor, and the method described herein, the L1/L2 message includes a MAC header and a MAC payload, the MAC header including the security header and the MAC payload including one or more MAC SDUs, the one or more MAC-CEs, and one or more of a MAC-I for the one or more MAC-CEs or an IE indicating timing information for replay protection for the one or more MAC-CEs.

### BRIEF DESCRIPTION OF THE DRAWINGS

FIG. 1 illustrates an example of a wireless communications system in accordance with aspects of the present disclosure.

FIG. 2 illustrates an example of a process flow for lower layer security distribution and activation in accordance with aspects of the present disclosure.

FIG. 3 illustrates an example of a MAC packet data unit (PDU) format in accordance with aspects of the present disclosure.

FIGS. 4 through 7 illustrate examples of lower layer security policy formats in accordance with aspects of the present disclosure.

FIG. 8 illustrates an example of a UE in accordance with aspects of the present disclosure.

FIG. 9 illustrates an example of a processor in accordance with aspects of the present disclosure.

FIG. 10 illustrates an example of an NE in accordance with aspects of the present disclosure.

FIG. 11 illustrates a flowchart of a method performed by a UE in accordance with aspects of the present disclosure.

FIG. 12 illustrates a flowchart of a method performed by an NE in accordance with aspects of the present disclosure.

### DETAILED DESCRIPTION

In a wireless communications system, a UE and an NE (e.g., a base station, gNB) may support wireless communication (e.g., reception and/or transmission) using time-frequency resources. The UE and the NE may communicate via higher layer signaling, such as RRC signaling, and lower layer (L1/L2) signaling, such as MAC-CE messages. In some examples, MAC-CEs may be carried via MAC PDUs, and may be used to convey status information and commands such as activating or deactivating cells, triggering channel state information (CSI) and buffer status reporting, and so forth.

In some wireless communication systems (e.g., 5G NR systems and beyond), lower layer (L1/L2) MAC-CE messages may lack the same level of security as higher layer signaling. Implications of such a lack of protection include denial of service (DoS), UE privacy vulnerabilities, attacks on performance optimization or resource utilization (e.g., battery consumption), and so forth. Additionally, UEs and NEs may lack support for a lower layer security policy, and the UEs and NEs lack methods for indicating how to apply (e.g., one or more rules for applying) such a security policy to a specific MAC-CE (e.g., whether integrity protection, confidentiality protection, replay protection, or a combination thereof is required).

Aspects of the present disclosure are described in the context of a wireless communications system, and include implementations that provide for distribution and activation of a lower layer security policy. A database (e.g., a unified data management (UDM)) may store a lower layer security policy per subscription and per UE. The database (e.g., a network function supporting the database) may transfer (e.g., transmit, communicate) the lower layer security policy to a network function, such as a non-access stratum (NAS) termination function (e.g., an access and mobility management function (AMF) or a session management function (SMF)), at the time of a PDU session establishment. The network function may then transfer (e.g., transmit, communicate) the lower layer security policy to an NE, where the lower layer security policy is used for protecting one or more MAC-CEs. A UE may receive an RRC message from the NE including a lower layer security policy. After the NE applies the lower layer security policy to the one or more MAC-CEs, the UE or the NE may transmit the MAC-CEs on a MAC layer according to the protection detailed in the lower layer security policy (e.g., one or more of integrity protection, confidentiality protection, or replay protection). A security header of the MAC PDU may indicate the lower layer security policy. That is, the UE may receive, from the NE, an L1/L2 message including a security header and the one or more MAC-CEs, the security header indicating that the one or more MAC-CEs are protected according to the lower layer security policy. The UE may verify the one or more MAC-CEs based on the security header. In some examples, various MAC-CEs may be protected using the same or different security policies with respect to one or more of integrity protection, confidentiality protection, or replay protection.

By performing the described techniques, a device in a wireless communications system can improve the security of lower layer communications between a UE and an NE. Specifically, the described techniques provide a mechanism for enabling security for lower layers (i.e., MAC layer security) over a radio interface. The described techniques improve security by enabling the distribution and activation of a lower layer security policy which includes various security settings (e.g., integrity protection, confidentiality protection, or replay protection) per individual MAC-CE, per group of MAC-CEs, or for all MAC-CEs in the MAC layer. In addition, the described techniques improve resource consumption and efficiency by indicating the lower layer security policy in a security header (for individual MAC-CEs, for a group of MAC-CEs, or for all MAC-CEs) in an L1/L2 message including the protected MAC-CEs. That is, no additional signaling is used to indicate the lower layer security policy.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

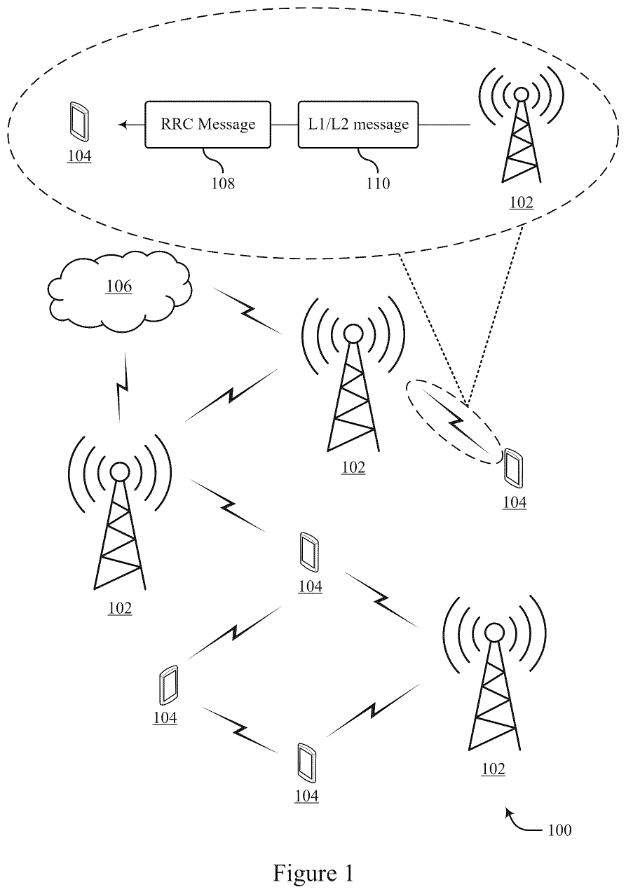

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHZ-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a lower layer security policy may be stored per subscription and per UE in a database (e.g., a UDM). The lower layer security policy may be transferred (e.g., transmitted, communicated) to a network function, such as an NAS termination function (e.g., an AMF or an SMF), at the time of a PDU session establishment. The network function may then transfer (e.g., transmit, communicate) the lower layer security policy to an NE 102, where the lower layer security policy is for protecting one or more MAC-CEs. A UE 104 may receive an RRC message 108 from the NE 102 including a lower layer security policy. After the NE 102 applies the lower layer security policy to the one or more MAC-CEs, the UE 104 or the NE 102 may transmit the MAC-CEs on a MAC layer according to the protection detailed in the lower layer security policy (e.g., one or more of integrity protection, confidentiality protection, or replay protection). The lower layer security policy may be indicated in a security header of a MAC PDU. That is, the UE 104 may receive, from the NE 102, an L1/L2 message 110 including a security header and the one or more MAC-CEs, the security header indicating that the one or more MAC-CEs are protected according to the lower layer security policy. The UE 104 may verify the one or more MAC-CEs based on the security header. In some examples, various MAC-CEs may be protected using the same or different security policies with respect to one or more of integrity protection, confidentiality protection, or replay protection.

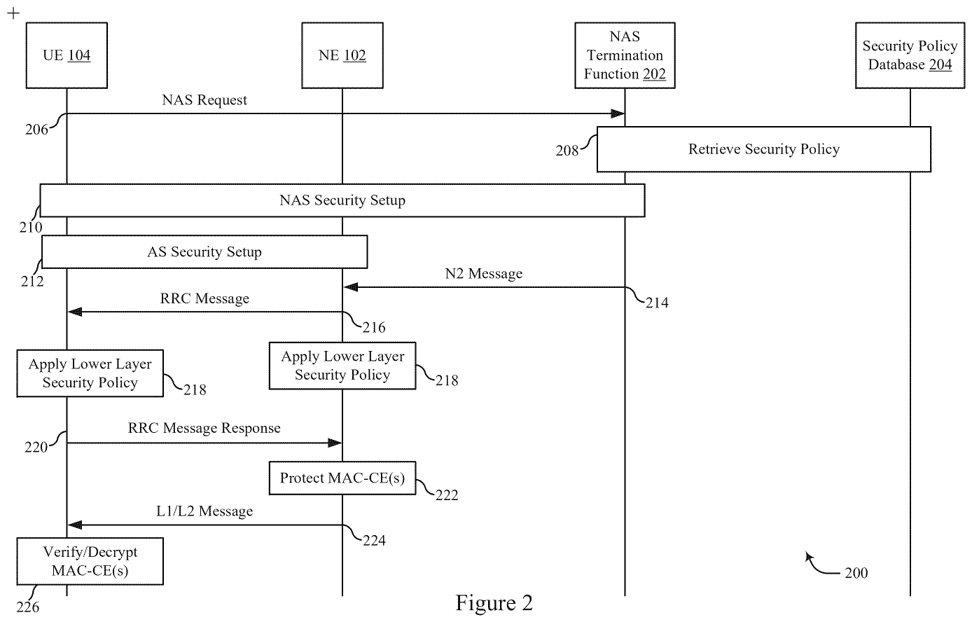

FIG. 2 illustrates an example of a process flow 200 in accordance with aspects of the present disclosure. The process flow 200 may be implemented in or supported by the wireless communications system 100. For example, the process flow 200 may be performed or enabled by a UE 104 and an NE 102 (e.g., a base station, a gNB), such as the UE 104 and the NE 102 described herein with reference to FIG. 1. In addition, the process flow 200 may be performed or enabled by a NAS termination function 202 (e.g., an AMF, an SMF) and a security policy database 204 (e.g., a UDM). The process flow 200 may support distribution and activation of a lower layer security policy for MAC-CEs.

At 206, the UE 104 may transmit a NAS request to the NAS termination function 202. The NAS request may be a PDU session establishment request or another message associated with PDU session establishment. In the example of the process flow 200, lower layer security policies for MAC-CEs may be stored per subscription and per UE in the security policy database 204. As such, at 208 in response to receiving the NAS request, the NAS termination function 202 may retrieve a security policy (e.g., a security policy for the user plane and lower layers) from the security policy database 204. In cases where the security policy database 204 is a UDM, for example, the NAS termination function 202 may retrieve a lower layer security policy from the UDM with a given subscription profile.

At 210, if it has not already been performed, the UE 104 and the NAS termination function 202 may perform an NAS security setup. In such cases, the UE 104 and the NAS termination function 202 may create (e.g., setup, establish) a security context by performing a NAS security command procedure, which includes a NAS security mode command.

At 212, if it has not already been performed, the UE 104 and the NE 102 may perform an access stratum (AS) security setup. In such cases, the UE 104 and the NE 102 may create (e.g., setup, establish) a security context by performing an AS security command procedure, which includes an AS security mode command.

At 214, the NAS termination function 202 may transmit an N2 message (e.g., a control plane signaling message sent over the N2 interface) to the NE 102. The N2 message may include an NAS message response, a user plane security policy (e.g., per data radio bearer (DRB)), and the lower layer security policy. In this way, the lower layer security policy is transferred (e.g., communicated, transmitted) to the NE 102.

At 216, the NE 102 transmits an RRC message to the UE 104, the RRC message including the lower layer security policy. In addition, the RRC message may include the NAS message response and the user plane security policy included in the N2 message transmitted from the NAS termination function 202 to the NE 102. The RRC message may be a protected RRC message (i.e., have some security protection).

At 218, the UE 104 and the NE 102 may apply the lower layer security policy to one or more MAC-CEs in the MAC layer. In some examples, the UE 104 and the NE 102 may also apply the user plane security policy to the user plane. At 220, after application of the security policies, the UE 104 may transmit a protected RRC message response to the NE 102.

At 222, in response to receiving the RRC message response from the UE 104, the NE 102 may determine to transmit one or more MAC-CEs to the UE 104. As such, the NE 102 may protect the MAC-CEs according to the lower layer security policy. That is, the NE 102 may apply the lower layer security policy to one or more MAC-CEs, which may include applying one or more of integrity protection, confidentiality protection, or replay protection.

At 224, the UE 104 may receive, from the NE 102, an L1/L2 message that includes a security header and the one or more MAC-CEs, where the security header indicates that the one or more MAC-CEs are protected according to the lower layer security policy. That is, the security header may indicate how the one or more MAC-CEs are protected (e.g., integrity protection (yes/no), confidentiality protection (yes/no), replay protection (yes/no)). In addition to the security header and the one or more MAC-CEs, the L1/L2 message may further include one or more MAC-Is (i.e., for each of the one or more MAC-CEs) if integrity protection is enabled.

At 226, the UE 104 may verify the MAC-CEs according to the security header received in the L1/L2 message. If encryption is enabled, the UE 104 may decrypt the MAC-CEs. Additionally, or alternatively, if integrity protection is enabled, the UE 104 may verify the MAC-Is included in the L1/L2 message. The UE 104 may perform other verification actions based on whether confidentiality protection and/or replay protection are enabled and based on any other relevant information included in the L1/L2 message.

In some implementations, the actions at 222 (i.e., the NE 102 protecting the MAC-CEs), 224 (e.g., the NE 102 transmitting the L1/L2 message), and 226 (e.g., the UE 104 verifying the MAC-CEs) may be applied in the uplink direction for cases in which the UE 104 transmits one or more MAC-CEs to the NE 102. Additionally, the NE 102 and the UE 104 may use various techniques for applying one or more of integrity protection, confidentiality protection, or replay protection to the one or more MAC-CEs.

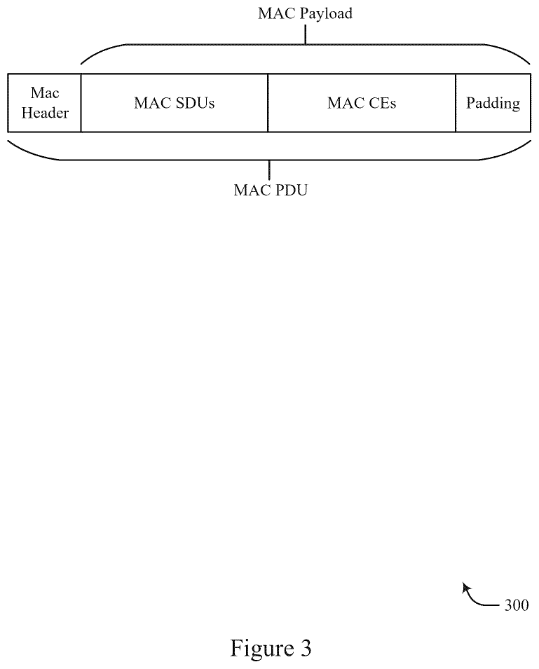

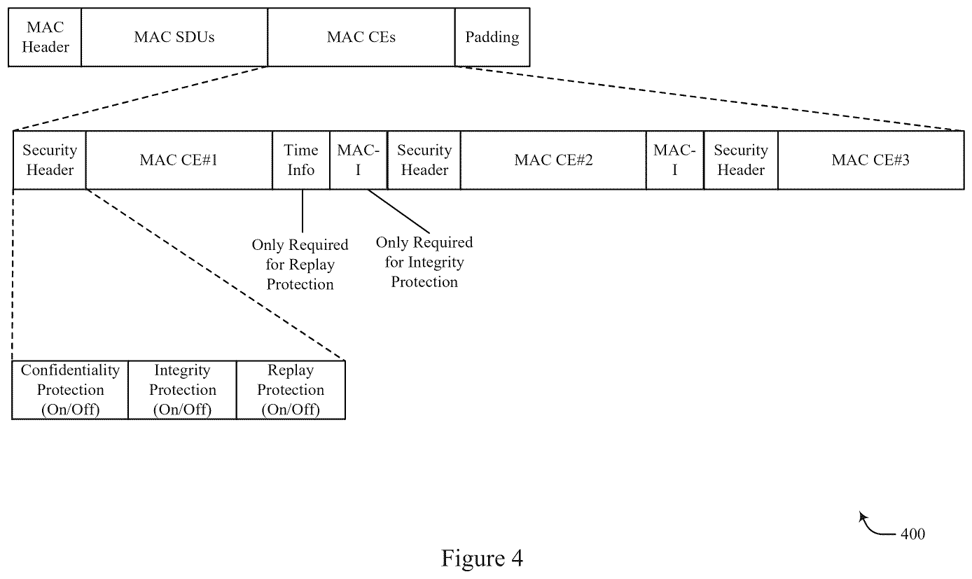

FIG. 3 illustrates an example of a MAC PDU format 300 in accordance with aspects of the present disclosure. The MAC PDU format 300 may be an example of a MAC PDU that may be included in an L1/L2 message, such as that described herein with reference to FIG. 2. In the example of FIG. 3, the MAC PDU may include a MAC header and a MAC payload. In some cases, the MAC header may include one or more consecutive MAC subheaders. The MAC payload is a concatenation of one or more MAC SDUs, one or more MAC-CEs, and padding. The MAC SDUs may include radio link control (RLC) PDUs from logical channels. The one or more MAC-CEs may include various information such as buffer status reports (BSRs), CSI reference signal resource indicators (CRIs), timing advance (TA) commands, discontinuous reception (DRX) information, power headroom reports (PHRs), secondary cell (SCell) activation/deactivation, and so forth. The padding may include one or more bits to fill the scheduled size of the MAC payload. As described herein with reference to FIGS. 4 through 7, the MAC PDU may be configured in various ways to enable MAC-CE protection.

FIG. 4 illustrates an example of a lower layer security policy format 400 in accordance with aspects of the present disclosure. In the lower layer security policy format 400, a MAC PDU may include a MAC header, one or more MAC SDUs, one or more MAC-CEs, and padding, as described herein with reference to FIG. 3. In this example, each MAC-CE in the MAC layer may be protected individually. That is, a particular lower layer security policy may be applied to each MAC-CE individually.

The lower layer security policy may list all possible MAC-CEs and their respective security policies with respect to integrity protection, confidentiality protection, and replay protection. Each MAC-CE may then have an individual security header and an individual MAC-I when integrity protection is enabled for that MAC-CE. As such, each individual security header indicates a respective lower layer security policy for each of the one or more MAC-CEs. For example, as shown in Table 1, integrity protection, confidentiality protection, and replay protection may be configured separately for each MAC-CE.

TABLE 1
Example Security Policy (Security Header)

| | Confidentiality | Integrity | Replay |
|---|---|---|---|
| MAC-CE | Protection | Protection | Protection |
| #1 | Yes | Yes | Yes |
| #2 | Yes | Yes | No |
| #3 | No | No | No |

Additionally, if replay protection is enabled for a MAC-CE, the lower layer security policy format 400 may include an IE indicating timing information (i.e., time info) such as sequence numbers, frame numbers, and so forth. In addition, if integrity protection is enabled for the MAC-CE, the lower layer security policy format 400 may include a MAC-CE for that MAC-CE. The timing information for replay protection may be used together with the MAC-I for integrity protection if both replay and integrity protection are enabled. In the example of FIG. 4, the lower layer security policy may list all possible MAC-CEs with their respective security requirements (e.g., confidentiality protection integrity protection, and replay protection). For example, the MAC-CEs included in the MAC payload may include a MAC-CE #1, a MAC-CE #2, and a MAC-CE #3. According to the information in Table 1, the MAC-CE #1, the MAC-CE #2, and the MAC-CE #3 may each have a respective security header. In addition, the MAC-CE #1 and the MAC-CE #2 may each have a corresponding MAC-I and the MAC-CE #1 may have an IE for timing information. In this example, the security header for the MAC-CE #1 may indicate that integrity protection, confidentiality protection, and replay protection are all “on” or “yes” (e.g., enabled).

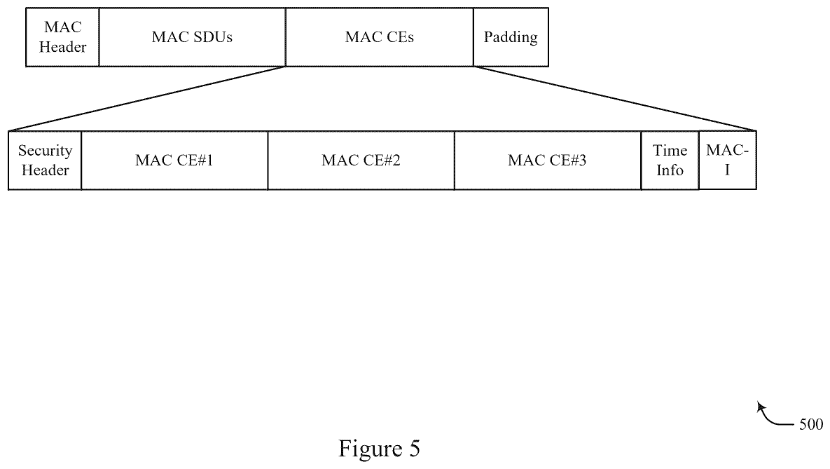

FIG. 5 illustrates an example of a lower layer security policy format 500 in accordance with aspects of the present disclosure. In the lower layer security policy format 500, a MAC PDU may include a MAC header, one or more MAC SDUs, one or more MAC-CEs, and padding, as described herein with reference to FIG. 3. In this example, all of the MAC-CEs in a same MAC PDU may be protected together, using a same lower layer security policy. That is, the lower layer security policy may list all MAC-CEs and their respective security policies with respect to integrity protection, confidentiality protection, and replay protection.

In some examples, MAC-CEs excluded from (not listed in) the lower layer security policy may not require security protection. In this way, the lower layer security policy may be the same for all MAC-CEs which require security protection. If MAC-CEs that do not require security protection are grouped in a same MAC PDU with other MAC-CEs that do require security protection, then the MAC-CEs that do not require security protection will be protected anyway as they are a part of the group. In this way, each group of MAC-CEs may have only one security header and one MAC-I in case integrity protection is enabled for at least one MAC-CE in the group. In the example of FIG. 5, the MAC-CE #1 and the MAC-CE #2 may each require security protection, while the MAC-CE #3 may not require security protection. However, since all three of the MAC-CE #1, the MAC-CE #2, and the MAC-CE #3 are transmitted together in a same MAC PDU, the MAC-CE #3 is included in the same group as the MAC-CE #1 and the MAC-CE #2 and as such, is included in the group-based security policy. For example, as shown in Table 2, integrity protection, confidentiality protection, and replay protection may be configured for the group of MAC-CEs.

TABLE 2
Example Security Policy (Security Header)

| | Confidentiality | Integrity | Replay |
|---|---|---|---|
| MAC-CE | Protection | Protection | Protection |
| #1 | Yes | Yes | Yes |
| #2 | Yes | Yes | Yes |
| #3 | Yes | Yes | Yes |

According to Table 2 for the lower layer security policy format 500, the security header for the MAC-CEs #1, #2, and #3 may indicate that integrity protection, confidentiality protection, and replay protection are “on” or “yes” (e.g., enabled). As the lower layer security policy is the same for all three MAC-CEs #1, #2, and #3, and given that integrity and replay protection are enabled, the same IE for timing information and the same MAC-I may also apply to all three MAC-CEs. In this way, the highest level of security for a MAC-CE within the MAC PDU may be used for (i.e., applied to) all MAC-CEs in that MAC PDU.

Alternatively, all of the MAC-CEs in the MAC layer may be treated in the same way according to a mobile operator policy, such that the lower layer security policy may be the same for all MAC-CEs. For example, each MAC-CE may require confidentiality protection (e.g., encryption) and replay protection but may not require integrity protection. When there are several MAC-CEs in one MAC PDU, then all of the MAC-CEs may be protected together in the same way, requiring only one security header, only one MAC-I (if integrity protection is enabled), and only one IE for timing information (if replay protection is enabled). As shown in Table 3, the security policy may be the same for all MAC-CEs and respectively represented in the security header (in terms of integrity protection, confidentiality protection, and replay protection).

TABLE 3
Example Security Policy (Security Header) for all MAC-CEs

| | Confidentiality | Integrity | Replay |
|---|---|---|---|
| MAC-CE | Protection | Protection | Protection |
| A11 | Yes | Yes | Yes |

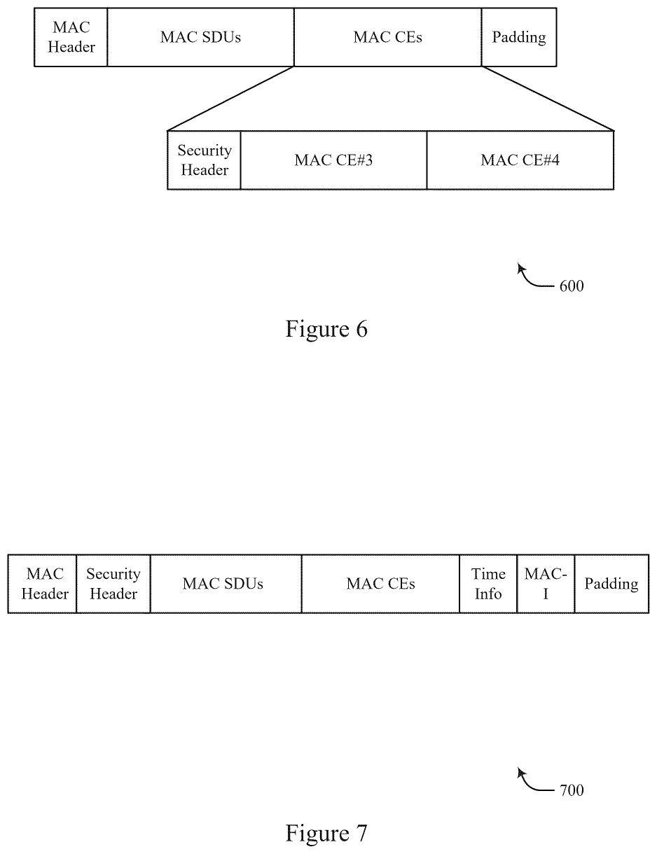

FIG. 6 illustrates an example of a lower layer security policy format 600 in accordance with aspects of the present disclosure. In this example, In the lower layer security policy format 600, a MAC PDU may include a MAC header, one or more MAC SDUs, one or more MAC-CEs, and padding, as described herein with reference to FIG. 3. In this example, all of the MAC-CEs in the MAC PDU may be protected in the same way (as described with reference to FIG. 5), however, neither the MAC-CE #3 nor the MAC-CE #4 may require any security protection. As such, as shown in Table 4, the security header for the MAC-CE #3 and the MAC-CE #4 may indicate “off” or “no” (e.g., not enabled) for integrity protection, confidentiality protection, and replay protection.

TABLE 4
Example Security Policy (Security Header)

| | Confidentiality | Integrity | Replay |
|---|---|---|---|
| MAC-CE | Protection | Protection | Protection |
| #3 | No | No | No |
| #4 | No | No | No |

In the example of FIG. 6, the lower layer security policy may list all possible MAC-CEs with their security requirements (e.g., integrity protection, confidentiality protection, and replay protection).

FIG. 7 illustrates an example of a lower layer security policy format 700 in accordance with aspects of the present disclosure. In the lower layer security policy format 700, the full MAC PDU may be protection-independent on the presence of one or more MAC-CEs. That is, the lower layer security policy may indicate how to handle MAC PDUs generally. As shown in Table 5, the security policy indicates the general handling of the MAC PDUs and is respectively represented in the security header (in terms of integrity protection, confidentiality protection, and replay protection).

TABLE 5
Example Security Policy (Security Header) for MAC PDUs

| | Confidentiality | Integrity | Replay |
|---|---|---|---|
| MAC-CE | Protection | Protection | Protection |
| A11 | Yes | Yes | Yes |

In the example of FIG. 7, the security header may become a part of the MAC header and the MAC payload may include additional IEs for timing information (if replay protection is enabled) and additional MAC-Is (if integrity protection is enabled) for the MAC PDU generally.

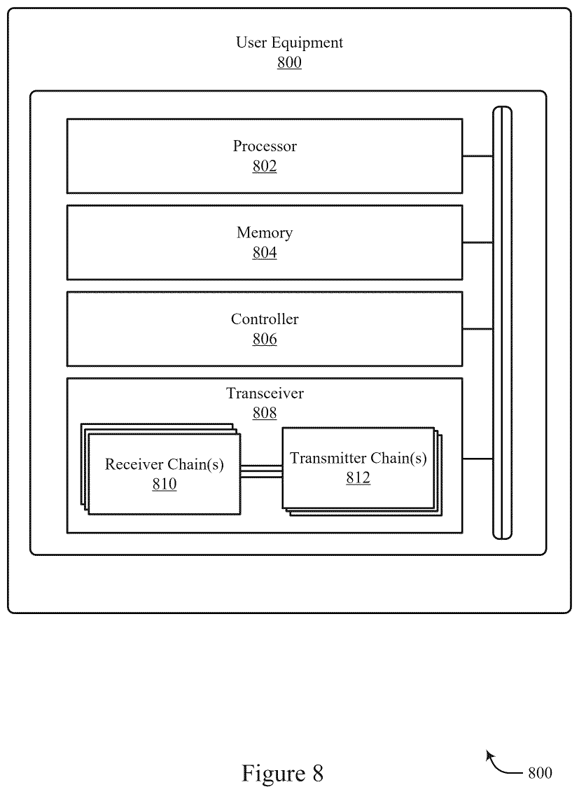

FIG. 8 illustrates an example of a UE 800 in accordance with aspects of the present disclosure. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions when executed by the processor 802 cause the UE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the UE 800 to perform one or more of the functions described herein (e.g., executing, by the processor 802, instructions stored in the memory 804). For example, the processor 802 may support wireless communication at the UE 800 in accordance with examples as disclosed herein. The UE 800 may be configured to or operable to support a means for receiving, from an NE, an RRC message including a lower layer security policy for protecting one or more MAC-CEs; receiving, from the NE, an L1/L2 message including a security header and the one or more MAC-CEs, the security header indicating that the one or more MAC-CEs are protected according to the lower layer security policy; and verifying the one or more MAC-CEs based on the security header. In this manner, the UE 800 enables security including integrity, confidentiality, and replay protection for lower layer messages such as MAC-CEs.

Additionally, the UE 800 may be configured to support any one or combination of the following. For example, the UE 800 may be configured to support where for each of the one or more MAC-CEs, the L1/L2 message includes a respective security header and a respective MAC-I, and where the respective security header indicates a respective lower layer security policy for each of the one or more MAC-CEs. This aspect improves signaling efficiency by indicating confidentiality and integrity protection via a security header of a MAC PDU. Additionally, or alternatively, the UE 800 may be configured to support where for each of the one or more MAC-CEs, the L1/L2 message includes a respective IE indicating timing information for replay protection. This aspect improves signaling efficiency by indicating replay protection via a security header of a MAC PDU.

Additionally, or alternatively, the UE 800 may be configured to support where the L1/L2 message includes the security header and a MAC-I for a group of MAC-CEs including at least one of the one or more MAC-CEs, and where the lower layer security policy is the same for the group of MAC-CEs. This aspect enables a single security policy to be indicated and activated for a group of MAC-CEs, avoiding the signaling of redundant security policies, thereby improving signaling efficiency and reducing resource consumption. Additionally, or alternatively, the UE 800 may be configured to support where the L1/L2 message includes an IE indicating timing information for replay protection for the group of MAC-CEs. This aspect enables a single security policy to be indicated and activated for a group of MAC-CEs, avoiding the signaling of redundant security policies, thereby improving signaling efficiency and reducing resource consumption.

Additionally, or alternatively, the UE 800 may be configured to support were at least one MAC-CE of the one or more MAC-CEs excluded from the group of MAC-CEs lack security protection according to the lower layer security policy. This aspect enables a single security policy to be indicated and activated for a group of MAC-CEs regardless of security requirements, reducing complexity, improving signaling efficiency, and reducing resource consumption. Additionally, or alternatively, the UE 800 may be configured to support where the L1/L2 message includes the security header and a MAC-I for the one or more MAC-CEs, and where the lower layer security policy is the same for the one or more MAC-CEs. This aspect enables a single security policy to be indicated and activated for all MAC-CEs in a MAC PDU, avoiding the signaling of redundant security policies, thereby improving signaling efficiency and reducing resource consumption.

Additionally, or alternatively, the UE 800 may be configured to support where the L1/L2 message includes an IE indicating timing information for replay protection for the one or more MAC-CEs. This aspect enables a single security policy to be indicated and activated for all MAC-CEs in a MAC PDU, avoiding the signaling of redundant security policies, thereby improving signaling efficiency and reducing resource consumption. Additionally, or alternatively, the UE 800 may be configured to support where the L1/L2 message includes a MAC header and a MAC payload, the MAC header including the security header and the MAC payload including one or more MAC SDUs, the one or more MAC-CEs, and one or more of a MAC-I for the one or more MAC-CEs or an IE indicating timing information for replay protection for the one or more MAC-CEs. This aspect enables a single security policy to be indicated and activated generally for a MAC PDU, avoiding the signaling of redundant security policies for individual MAC-CEs, thereby improving signaling efficiency and reducing resource consumption.

Additionally, or alternatively, the UE 800 may be configured to support where verifying the one or more MAC-CEs includes decrypting the one or more MAC-CEs when encryption is enabled and verify one or more MAC-Is when integrity protection is enabled. This aspect improves MAC-CE security and protection by requiring decryption for confidentiality-protected MAC-CEs. Additionally, or alternatively, the UE 800 may be configured to support where to indicate that the one or more MAC-CEs are protected according to the lower layer security policy, the security header includes one or more of an indication of whether confidentiality protection is enabled, an indication of whether integrity protection is enabled, or an indication of whether replay protection is enabled. This aspect enables security including integrity, confidentiality, and replay protection for MAC-CEs. Additionally, or alternatively, the UE 800 may be configured to support transmitting, to the NE, a protected response message in response to receiving the RRC message. This aspect reduces complexity by including lower layer security distribution and activation into a PDU session establishment procedure.

Additionally, or alternatively, the UE 800 may support at least one memory (e.g., the memory 804) and at least one processor (e.g., the processor 802) coupled with the at least one memory and configured to cause the UE to receive, from an NE, an RRC message including a lower layer security policy for protecting one or more MAC-CEs; receive, from the NE, an L1/L2 message including a security header and the one or more MAC-CEs, the security header indicating that the one or more MAC-CEs are protected according to the lower layer security policy; and verify the one or more MAC-CEs based on the security header. In this manner, the UE 800 enables security including integrity, confidentiality, and replay protection for lower layer messages such as MAC-CEs.

Additionally, the UE 800 may be configured to support any one or combination of the following. For example, the UE 800 may be configured to support where for each of the one or more MAC-CEs, the L1/L2 message includes a respective security header and a respective MAC-I, and where the respective security header indicates a respective lower layer security policy for each of the one or more MAC-CEs. This aspect improves signaling efficiency by indicating confidentiality and integrity protection via a security header of a MAC PDU. Additionally, or alternatively, the UE 800 may be configured to support where for each of the one or more MAC-CEs, the L1/L2 message includes a respective IE indicating timing information for replay protection. This aspect improves signaling efficiency by indicating replay protection via a security header of a MAC PDU.

Additionally, or alternatively, the UE 800 may be configured to support where the L1/L2 message includes the security header and a MAC-I for a group of MAC-CEs including at least one of the one or more MAC-CEs, and where the lower layer security policy is the same for the group of MAC-CEs. This aspect enables a single security policy to be indicated and activated for a group of MAC-CEs, avoiding the signaling of redundant security policies, thereby improving signaling efficiency and reducing resource consumption. Additionally, or alternatively, the UE 800 may be configured to support where the L1/L2 message includes an IE indicating timing information for replay protection for the group of MAC-CEs. This aspect enables a single security policy to be indicated and activated for a group of MAC-CEs, avoiding the signaling of redundant security policies, thereby improving signaling efficiency and reducing resource consumption.

Additionally, or alternatively, the UE 800 may be configured to support were at least one MAC-CE of the one or more MAC-CEs excluded from the group of MAC-CEs lack security protection according to the lower layer security policy. This aspect enables a single security policy to be indicated and activated for a group of MAC-CEs regardless of security requirements, reducing complexity, improving signaling efficiency, and reducing resource consumption. Additionally, or alternatively, the UE 800 may be configured to support where the L1/L2 message includes the security header and a MAC-I for the one or more MAC-CEs, and where the lower layer security policy is the same for the one or more MAC-CEs. This aspect enables a single security policy to be indicated and activated for all MAC-CEs in a MAC PDU, avoiding the signaling of redundant security policies, thereby improving signaling efficiency and reducing resource consumption.

Additionally, or alternatively, the UE 800 may be configured to support where the L1/L2 message includes an IE indicating timing information for replay protection for the one or more MAC-CEs. This aspect enables a single security policy to be indicated and activated for all MAC-CEs in a MAC PDU, avoiding the signaling of redundant security policies, thereby improving signaling efficiency and reducing resource consumption. Additionally, or alternatively, the UE 800 may be configured to support where the L1/L2 message includes a MAC header and a MAC payload, the MAC header including the security header and the MAC payload including one or more MAC SDUs, the one or more MAC-CEs, and one or more of a MAC-I for the one or more MAC-CEs or an IE indicating timing information for replay protection for the one or more MAC-CEs. This aspect enables a single security policy to be indicated and activated generally for a MAC PDU, avoiding the signaling of redundant security policies for individual MAC-CEs, thereby improving signaling efficiency and reducing resource consumption.

Additionally, or alternatively, the UE 800 may be configured to support where verifying the one or more MAC-CEs includes decrypting the one or more MAC-CEs when encryption is enabled and verify one or more MAC-Is when integrity protection is enabled. This aspect improves MAC-CE security and protection by requiring decryption for confidentiality-protected MAC-CEs. Additionally, or alternatively, the UE 800 may be configured to support where to indicate that the one or more MAC-CEs are protected according to the lower layer security policy, the security header includes one or more of an indication of whether confidentiality protection is enabled, an indication of whether integrity protection is enabled, or an indication of whether replay protection is enabled. This aspect enables security including integrity, confidentiality, and replay protection for MAC-CEs. Additionally, or alternatively, the UE 800 may be configured to support transmitting, to the NE, a protected response message in response to receiving the RRC message. This aspect reduces complexity by including lower layer security distribution and activation into a PDU session establishment procedure.

The controller 806 may manage input and output signals for the UE 800. The controller 806 may also manage peripherals not integrated into the UE 800. In some implementations, the controller 806 may utilize an operating system such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

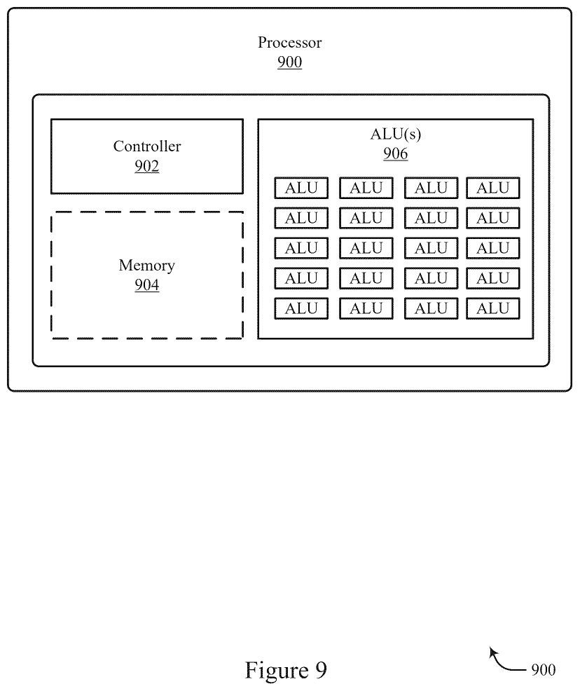

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory addresses of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, ALUs 906, and other functional units of the processor 900.

The memory 904 may include one or more caches (e.g., memory local to or included in the processor 900 or other memory, such as RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, and the controller 902, and may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 may be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

The processor 900 may support wireless communication in accordance with examples as disclosed herein. The processor 900 may be configured to or operable to support at least one controller (e.g., the controller 902) coupled with at least one memory (e.g., the memory 904) and configured to cause the processor to receive, from an NE, an RRC message including a lower layer security policy for protecting one or more MAC-CEs; receive, from the NE, an L1/L2 message including a security header and the one or more MAC-CEs, the security header indicating that the one or more MAC-CEs are protected according to the lower layer security policy; and verify the one or more MAC-CEs based on the security header. In this manner, the processor 900 enables security including integrity, confidentiality, and replay protection for lower layer messages such as MAC-CEs.

Additionally, the processor 900 may be configured to support any one or combination of the following. For example, the processor 900 may be configured to support where for each of the one or more MAC-CEs, the L1/L2 message includes a respective security header and a respective MAC-I, and where the respective security header indicates a respective lower layer security policy for each of the one or more MAC-CEs. This aspect improves signaling efficiency by indicating confidentiality and integrity protection via a security header of a MAC PDU. Additionally, or alternatively, the processor 900 may be configured to support where for each of the one or more MAC-CEs, the L1/L2 message includes a respective IE indicating timing information for replay protection. This aspect improves signaling efficiency by indicating replay protection via a security header of a MAC PDU.

Additionally, or alternatively, the processor 900 may be configured to support where the L1/L2 message includes the security header and a MAC-I for a group of MAC-CEs including at least one of the one or more MAC-CEs, and where the lower layer security policy is the same for the group of MAC-CEs. This aspect enables a single security policy to be indicated and activated for a group of MAC-CEs, avoiding the signaling of redundant security policies, thereby improving signaling efficiency and reducing resource consumption. Additionally, or alternatively, the processor 900 may be configured to support where the L1/L2 message includes an IE indicating timing information for replay protection for the group of MAC-CEs. This aspect enables a single security policy to be indicated and activated for a group of MAC-CEs, avoiding the signaling of redundant security policies, thereby improving signaling efficiency and reducing resource consumption.

Additionally, or alternatively, the processor 900 may be configured to support were at least one MAC-CE of the one or more MAC-CEs excluded from the group of MAC-CEs lack security protection according to the lower layer security policy. This aspect enables a single security policy to be indicated and activated for a group of MAC-CEs regardless of security requirements, reducing complexity, improving signaling efficiency, and reducing resource consumption. Additionally, or alternatively, the processor 900 may be configured to support where the L1/L2 message includes the security header and a MAC-I for the one or more MAC-CEs, and where the lower layer security policy is the same for the one or more MAC-CEs. This aspect enables a single security policy to be indicated and activated for all MAC-CEs in a MAC PDU, avoiding the signaling of redundant security policies, thereby improving signaling efficiency and reducing resource consumption.

Additionally, or alternatively, the processor 900 may be configured to support where the L1/L2 message includes an IE indicating timing information for replay protection for the one or more MAC-CEs. This aspect enables a single security policy to be indicated and activated for all MAC-CEs in a MAC PDU, avoiding the signaling of redundant security policies, thereby improving signaling efficiency and reducing resource consumption. Additionally, or alternatively, the processor 900 may be configured to support where the L1/L2 message includes a MAC header and a MAC payload, the MAC header including the security header and the MAC payload including one or more MAC SDUs, the one or more MAC-CEs, and one or more of a MAC-I for the one or more MAC-CEs or an IE indicating timing information for replay protection for the one or more MAC-CEs. This aspect enables a single security policy to be indicated and activated generally for a MAC PDU, avoiding the signaling of redundant security policies for individual MAC-CEs, thereby improving signaling efficiency and reducing resource consumption.

Additionally, or alternatively, the processor 900 may be configured to support where verifying the one or more MAC-CEs includes decrypting the one or more MAC-CEs when encryption is enabled and verify one or more MAC-Is when integrity protection is enabled. This aspect improves MAC-CE security and protection by requiring decryption for confidentiality-protected MAC-CEs. Additionally, or alternatively, the processor 900 may be configured to support where to indicate that the one or more MAC-CEs are protected according to the lower layer security policy, the security header includes one or more of an indication of whether confidentiality protection is enabled, an indication of whether integrity protection is enabled, or an indication of whether replay protection is enabled. This aspect enables security including integrity, confidentiality, and replay protection for MAC-CEs. Additionally, or alternatively, the processor 900 may be configured to support transmitting, to the NE, a protected response message in response to receiving the RRC message. This aspect reduces complexity by including lower layer security distribution and activation into a PDU session establishment procedure.

Additionally, or alternatively, the processor 900 may support wireless communication in accordance with examples as disclosed herein. The processor 900 may be configured to or operable to support at least one controller (e.g., the controller 902) coupled with at least one memory (e.g., the memory 904) and configured to cause the processor to receive, from a network function, a lower layer security policy for protecting one or more MAC-CEs; transmit, to a UE, an RRC message including the lower layer security policy; apply the lower layer security policy to the one or more MAC-CEs; and transmit, to the UE, an L1/L2 message including a security header and the one or more MAC-CEs, the security header indicating that the one or more MAC-CEs are protected according to the lower layer security policy. In this manner, the processor 900 enables security including integrity, confidentiality, and replay protection for lower layer messages such as MAC-CEs.

Additionally, the processor 900 may be configured to support any one or combination of the following. For example, the processor 900 may be configured to support where for each of the one or more MAC-CEs, the L1/L2 message includes a respective security header and a respective MAC-I, and where the respective security header indicates a respective lower layer security policy for each of the one or more MAC-CEs. This aspect improves signaling efficiency by indicating confidentiality and integrity protection via a security header of a MAC PDU. Additionally, or alternatively, the processor 900 may be configured to support where for each of the one or more MAC-CEs, the L1/L2 message includes a respective IE indicating timing information for replay protection. This aspect improves signaling efficiency by indicating replay protection via a security header of a MAC PDU.

Additionally, or alternatively, the processor 900 may be configured to support where the L1/L2 message includes the security header and a MAC-I for a group of MAC-CEs including at least one of the one or more MAC-CEs, and where the lower layer security policy is the same for the group of MAC-CEs. This aspect enables a single security policy to be indicated and activated for a group of MAC-CEs, avoiding the signaling of redundant security policies, thereby improving signaling efficiency and reducing resource consumption. Additionally, or alternatively, the processor 900 may be configured to support where the L1/L2 message includes the security header and a MAC-I for the one or more MAC-CEs, and where the lower layer security policy is the same for the one or more MAC-CEs. This aspect enables a single security policy to be indicated and activated for a group of MAC-CEs, avoiding the signaling of redundant security policies, thereby improving signaling efficiency and reducing resource consumption.

Additionally, or alternatively, the processor 900 may be configured to support where the L1/L2 message includes a MAC header and a MAC payload, the MAC header including the security header and the MAC payload including one or more MAC SDUs, the one or more MAC-CEs, and one or more of a MAC-I for the one or more MAC-CEs or an IE indicating timing information for replay protection for the one or more MAC-CEs. This aspect enables security including integrity, confidentiality, and replay protection for MAC-CEs.

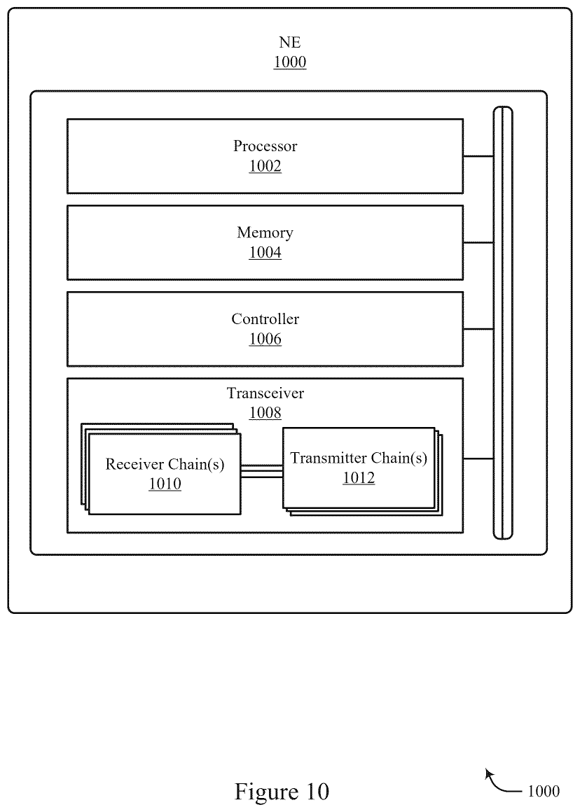

FIG. 10 illustrates an example of an NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform one or more of the functions described herein (e.g., executing, by the processor 1002, instructions stored in the memory 1004). For example, the processor 1002 may support wireless communication at the NE 1000 in accordance with examples as disclosed herein. The NE 1000 may be configured to or operable to support a means for receiving, from a network function, a lower layer security policy for protecting one or more MAC-CEs; transmitting, to a UE, an RRC message including the lower layer security policy; applying the lower layer security policy to the one or more MAC-CEs; and transmitting, to the UE, an L1/L2 message including a security header and the one or more MAC-CEs, the security header indicating that the one or more MAC-CEs are protected according to the lower layer security policy. In this manner, the NE 1000 enables security including integrity, confidentiality, and replay protection for lower layer messages such as MAC-CEs.

Additionally, the NE 1000 may be configured to support any one or combination of the following. For example, the NE 1000 may be configured to support where for each of the one or more MAC-CEs, the L1/L2 message includes a respective security header and a respective MAC-I, and where the respective security header indicates a respective lower layer security policy for each of the one or more MAC-CEs. This aspect improves signaling efficiency by indicating confidentiality and integrity protection via a security header of a MAC PDU. Additionally, or alternatively, the NE 1000 may be configured to support where for each of the one or more MAC-CEs, the L1/L2 message includes a respective IE indicating timing information for replay protection. This aspect improves signaling efficiency by indicating replay protection via a security header of a MAC PDU.

Additionally, or alternatively, the NE 1000 may be configured to support where the L1/L2 message includes the security header and a MAC-I for a group of MAC-CEs including at least one of the one or more MAC-CEs, and where the lower layer security policy is the same for the group of MAC-CEs. This aspect enables a single security policy to be indicated and activated for a group of MAC-CEs, avoiding the signaling of redundant security policies, thereby improving signaling efficiency and reducing resource consumption. Additionally, or alternatively, the NE 1000 may be configured to support where the L1/L2 message includes the security header and a MAC-I for the one or more MAC-CEs, and where the lower layer security policy is the same for the one or more MAC-CEs. This aspect enables a single security policy to be indicated and activated for a group of MAC-CEs, avoiding the signaling of redundant security policies, thereby improving signaling efficiency and reducing resource consumption.

Additionally, or alternatively, the NE 1000 may be configured to support where the L1/L2 message includes a MAC header and a MAC payload, the MAC header including the security header and the MAC payload including one or more MAC SDUs, the one or more MAC-CEs, and one or more of a MAC-I for the one or more MAC-CEs or an IE indicating timing information for replay protection for the one or more MAC-CEs. This aspect enables security including integrity, confidentiality, and replay protection for MAC-CEs.

Additionally, or alternatively, the NE 1000 may support at least one memory (e.g., the memory 1004) and at least one processor (e.g., the processor 1002) coupled with the at least one memory and configured to cause the NE to receive, from a network function, a lower layer security policy for protecting one or more MAC-CEs; transmit, to a UE, an RRC message including the lower layer security policy; apply the lower layer security policy to the one or more MAC-CEs; and transmit, to the UE, an L1/L2 message including a security header and the one or more MAC-CEs, the security header indicating that the one or more MAC-CEs are protected according to the lower layer security policy. In this manner, the NE 1000 enables security including integrity, confidentiality, and replay protection for lower layer messages such as MAC-CEs.

Additionally, the NE 1000 may be configured to support any one or combination of the following. For example, the NE 1000 may be configured to support where for each of the one or more MAC-CEs, the L1/L2 message includes a respective security header and a respective MAC-I, and where the respective security header indicates a respective lower layer security policy for each of the one or more MAC-CEs. This aspect improves signaling efficiency by indicating confidentiality and integrity protection via a security header of a MAC PDU. Additionally, or alternatively, the NE 1000 may be configured to support where for each of the one or more MAC-CEs, the L1/L2 message includes a respective IE indicating timing information for replay protection. This aspect improves signaling efficiency by indicating replay protection via a security header of a MAC PDU.

Additionally, or alternatively, the NE 1000 may be configured to support where the L1/L2 message includes the security header and a MAC-I for a group of MAC-CEs including at least one of the one or more MAC-CEs, and where the lower layer security policy is the same for the group of MAC-CEs. This aspect enables a single security policy to be indicated and activated for a group of MAC-CEs, avoiding the signaling of redundant security policies, thereby improving signaling efficiency and reducing resource consumption. Additionally, or alternatively, the NE 1000 may be configured to support where the L1/L2 message includes the security header and a MAC-I for the one or more MAC-CEs, and where the lower layer security policy is the same for the one or more MAC-CEs. This aspect enables a single security policy to be indicated and activated for a group of MAC-CEs, avoiding the signaling of redundant security policies, thereby improving signaling efficiency and reducing resource consumption.

Additionally, or alternatively, the NE 1000 may be configured to support where the L1/L2 message includes a MAC header and a MAC payload, the MAC header including the security header and the MAC payload including one or more MAC SDUs, the one or more MAC-CEs, and one or more of a MAC-I for the one or more MAC-CEs or an IE indicating timing information for replay protection for the one or more MAC-CEs. This aspect enables security including integrity, confidentiality, and replay protection for MAC-CEs.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

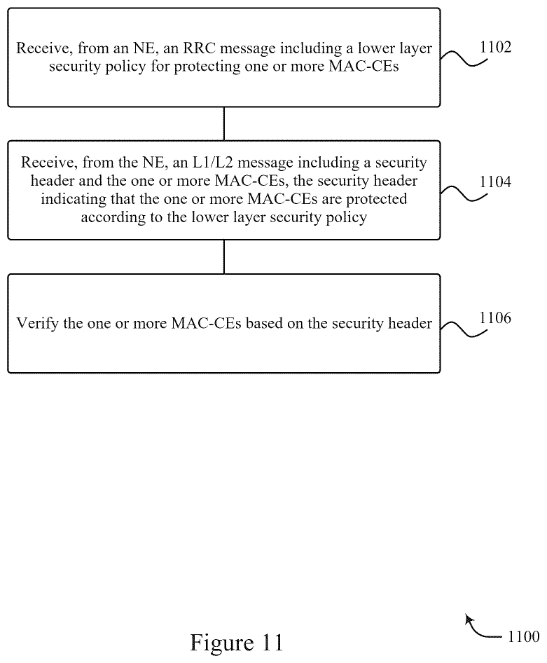

FIG. 11 illustrates a flowchart of a method 1100 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1102, the method may include receiving, from an NE, an RRC message including a lower layer security policy for protecting one or more MAC-CEs. The operations of 1102 may be performed in accordance with examples as described herein. In some implementations, aspects of the operations of 1102 may be performed by a UE as described with reference to FIG. 8.

At 1104, the method may include receiving, from the NE, an L1/L2 message including a security header and the one or more MAC-CEs, the security header indicating that the one or more MAC-CEs are protected according to the lower layer security policy. The operations of 1104 may be performed in accordance with examples as described herein. In some implementations, aspects of the operations of 1104 may be performed by a UE as described with reference to FIG. 8.

At 1106, the method may include verifying the one or more MAC-CEs based on the security header. The operations of 1106 may be performed in accordance with examples as described herein. In some implementations, aspects of the operations of 1106 may be performed a UE as described with reference to FIG. 8.

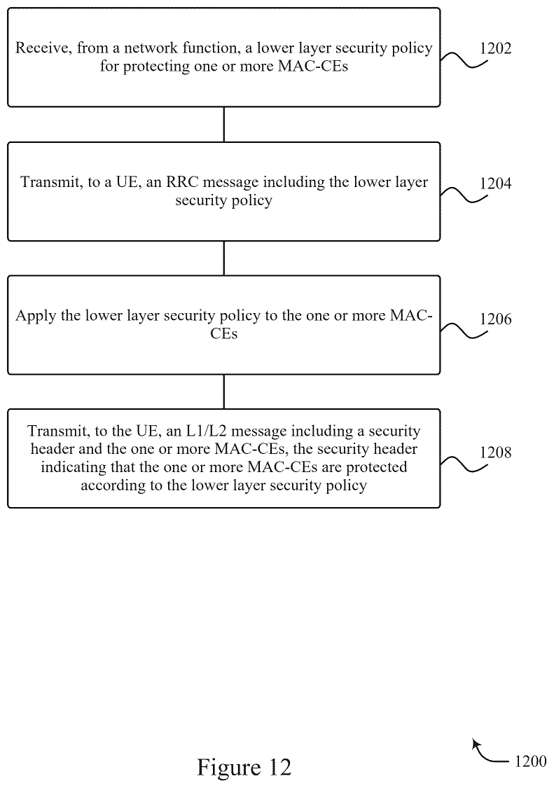

FIG. 12 illustrates a flowchart of a method 1200 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1202, the method may include receiving, from a network function, a lower layer security policy for protecting one or more MAC-CEs. The operations of 1202 may be performed in accordance with examples as described herein. In some implementations, aspects of the operations of 1202 may be performed by an NE as described with reference to FIG. 10.

At 1204, the method may include transmitting, to a UE, an RRC message including the lower layer security policy. The operations of 1204 may be performed in accordance with examples as described herein. In some implementations, aspects of the operations of 1204 may be performed by an NE as described with reference to FIG. 10.

At 1206, the method may include applying the lower layer security policy to the one or more MAC-CEs. The operations of 1206 may be performed in accordance with examples as described herein. In some implementations, aspects of the operations of 1206 may be performed an NE as described with reference to FIG. 10.

At 1208, the method may include transmitting, to the UE, an L1/L2 message including a security header and the one or more MAC-CEs, the security header indicating that the one or more MAC-CEs are protected according to the lower layer security policy. The operations of 1208 may be performed in accordance with examples as described herein. In some implementations, aspects of the operations of 1208 may be performed an NE as described with reference to FIG. 10.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive, from a network equipment (NE), a radio resource control (RRC) message comprising a lower layer security policy for protecting one or more medium access control (MAC) control elements (MAC-CEs);
receive, from the NE, a layer 1 (L1)/layer 2 (L2) message comprising a security header and the one or more MAC-CEs, the security header indicating that the one or more MAC-CEs are protected according to the lower layer security policy; and
verify the one or more MAC-CEs based at least in part on the security header.

2. The UE of claim 1, wherein, for each of the one or more MAC-CEs, the L1/L2 message comprises a respective security header and a respective message authentication code for integrity (MAC-I), and wherein the respective security header indicates a respective lower layer security policy for each of the one or more MAC-CEs.

3. The UE of claim 2, wherein, for each of the one or more MAC-CEs, the L1/L2 message comprises a respective information element (IE) indicating timing information for replay protection.

4. The UE of claim 1, wherein the L1/L2 message comprises the security header and a message authentication code for integrity (MAC-I) for a group of MAC-CEs including at least one of the one or more MAC-CEs, and wherein the lower layer security policy is the same for the group of MAC-CEs.

5. The UE of claim 4, wherein the L1/L2 message comprises an information element (IE) indicating timing information for replay protection for the group of MAC-CEs.

6. The UE of claim 4, wherein at least one MAC-CE of the one or more MAC-CEs excluded from the group of MAC-CEs lack security protection according to the lower layer security policy.

7. The UE of claim 1, wherein the L1/L2 message comprises the security header and a message authentication code for integrity (MAC-I) for the one or more MAC-CEs, and wherein the lower layer security policy is the same for the one or more MAC-CEs.

8. The UE of claim 7, wherein the L1/L2 message comprises an information element (IE) indicating timing information for replay protection for the one or more MAC-CEs.

9. The UE of claim 1, wherein the L1/L2 message comprises a MAC header and a MAC payload, the MAC header including the security header and the MAC payload including one or more MAC service data units (SDUs), the one or more MAC-CEs, and one or more of a message authentication code for integrity (MAC-I) for the one or more MAC-CEs or an information element (IE) indicating timing information for replay protection for the one or more MAC-CEs.

10. The UE of claim 1, wherein, to verify the one or more MAC-CEs, the at least one processor is further operable to cause the UE to decrypt the one or more MAC-CEs when encryption is enabled and verify one or more message authentication codes for integrity (MAC-Is) when integrity protection is enabled.

11. The UE of claim 1, wherein, to indicate that the one or more MAC-CEs are protected according to the lower layer security policy, the security header includes one or more of an indication of whether confidentiality protection is enabled, an indication of whether integrity protection is enabled, or an indication of whether replay protection is enabled.

12. The UE of claim 1, wherein the at least one processor is further operable to cause the UE to transmit, to the NE, a protected response message in response to receiving the RRC message.

13. A network equipment (NE) for wireless communication, comprising:
at least one memory; and
at least one processor coupled with the at least one memory and operable to cause the NE to:
receive, from a network function, a lower layer security policy for protecting one or more medium access control (MAC) control elements (MAC-CEs);
transmit, to a user equipment (UE), a radio resource control (RRC) message comprising the lower layer security policy;
apply the lower layer security policy to the one or more MAC-CEs; and
transmit, to the UE, a layer 1 (L1)/layer 2 (L2) message comprising a security header and the one or more MAC-CEs, the security header indicating that the one or more MAC-CEs are protected according to the lower layer security policy.

14. The NE of claim 13, wherein, for each of the one or more MAC-CEs, the L1/L2 message comprises a respective security header and a respective message authentication code for integrity (MAC-I), and wherein the respective security header indicates a respective lower layer security policy for each of the one or more MAC-CEs.

15. The NE of claim 14, wherein, for each of the one or more MAC-CEs, the L1/L2 message comprises a respective information element (IE) indicating timing information for replay protection.

16. The NE of claim 13, wherein the L1/L2 message comprises the security header and a message authentication code for integrity (MAC-I) for a group of MAC-CEs including at least one of the one or more MAC-CEs, and wherein the lower layer security policy is the same for the group of MAC-CEs.

17. The NE of claim 13, wherein the L1/L2 message comprises the security header and a message authentication code for integrity (MAC-I) for the one or more MAC-CEs, and wherein the lower layer security policy is the same for the one or more MAC-CEs.

18. The NE of claim 13, wherein the L1/L2 message comprises a MAC header and a MAC payload, the MAC header including the security header and the MAC payload including one or more MAC service data units (SDUs), the one or more MAC-CEs, and one or more of a message authentication code for integrity (MAC-I) for the one or more MAC-CEs or an information element (IE) indicating timing information for replay protection for the one or more MAC-CEs.

19. A method performed by a user equipment (UE), the method comprising:
receiving, from a network equipment (NE), a radio resource control (RRC) message comprising a lower layer security policy for protecting one or more medium access control (MAC) control elements (MAC-CEs);
receiving, from the NE, a layer 1 (L1)/layer 2 (L2) message comprising a security header and the one or more MAC-CEs, the security header indicating that the one or more MAC-CEs are protected according to the lower layer security policy; and
verifying the one or more MAC-CEs based at least in part on the security header.

20. A method performed by a network equipment (NE), the method comprising:
receiving, from a network function, a lower layer security policy for protecting one or more medium access control (MAC) control elements (MAC-CEs);
transmitting, to a user equipment (UE), a radio resource control (RRC) message comprising the lower layer security policy;
applying the lower layer security policy to the one or more MAC-CEs; and
transmitting, to the UE, a layer 1 (L1)/layer 2 (L2) message comprising a security header and one or more MAC-CEs, the security header indicating that the one or more MAC-CEs are protected according to the lower layer security policy.
